(19) United States
(12) Patent Application Publication
(10) Pub. No.: US 2021/0331395 A1
(43) Pub. Date: Oct. 28, 2021

(54) EXTRACTING BUILD MATERIAL

(71) Applicant: HEWLETT-PACKARD DEVELOPMENT COMPANY, L.P., Spring, TX (US)

(72) Inventors: David Chanclon Fernandez, Sant Cugat del Valles (ES); Arturo Garcia Gomez, Sant Cugat del Valles (ES); Marti Cot Ponti, Sant Cugat del Valles (ES); Ernesto Alejandro Jones Poppescou, Sant Cugat del Valles (ES); Ivan Ferrero Carreres, Sant Cugat del Valles (ES); Xavier Miguel Royo, Sant Cugat del Valles (ES)

(21) Appl. No.: 16/608,229

(22) PCT Filed: May 11, 2018
(86) PCT No.: PCT/US2018/032277

§ 371 Date: Oct. 25, 2019

(51) Int. Cl. B29C 64/321; B29C 64/393; B33Y 30/00; B33Y 50/02; B33Y 40/00

(52) U.S. Cl. CPC B29C 64/321; B29C 64/393; B33Y 40/00; B33Y 50/02; B33Y 30/00

(57) ABSTRACT

An example of an apparatus to transfer additive manufacturing build material from a container is disclosed. The example disclosed herein comprises a holding structure and a conduit. The holding structure comprises a fixation element to physically attach the holding structure to one or multiple sides of the container. The conduit may be couplable to a vacuum system through a vacuum open end to extract the build material. The holding structure receives and positions the conduit substantially vertically such that a build material extraction open end of the conduit is positioned towards the base of the container. The vacuum open end and the build material extraction open end are opposite open ends from the conduit.

### BACKGROUND

Some additive manufacturing systems use build materials to build three dimensional objects. Said additive manufacturing systems may comprise a build material processing unit therein or externally connected to supply build material to the three dimensional printer (e.g., 3D build chamber). The build material processing units may comprise at least one container comprising build material along with some mechanism to supply said build material to the additive manufacturing systems attached thereto.

Customers may acquire build materials in larger containers than the build material processing unit inner container. In some examples, build materials from said larger containers may be extracted to refill the build material processing unit inner container from said additive manufacturing system with build material.

### BRIEF DESCRIPTION OF THE DRAWINGS

The present application may be more fully appreciated in connection with the following detailed description taken in conjunction with the accompanying drawings, in which like reference characters refer to like parts throughout and in which:

FIG. 1 is a block diagram illustrating an example of an apparatus to extracting build material.

FIG. 2 is a schematic diagram illustrating an example of an apparatus to extracting build material.

FIG. 3 is a schematic diagram illustrating another example of an apparatus to extracting build material.

FIG. 4 is a schematic top view diagram illustrating an example of a holding structure.

FIG. 5A is a schematic diagram illustrating an example of a conduit.

FIG. 5B is a schematic diagram illustrating a cross-section example of a conduit.

FIG. 6 is a schematic diagram illustrating another cross-section example of a portion of a conduit.

FIG. 7 is a schematic diagram illustrating another example of an apparatus to extracting build material.

FIG. 8 is a schematic diagram illustrating another example of an apparatus to extracting build material.

FIG. 9 is a flowchart of an example method for extracting build material.

### DETAILED DESCRIPTION

The following description is directed to various examples of the disclosure. In the foregoing description, numerous details are set forth to provide an understanding of the examples disclosed herein. However, it will be understood by those skilled in the art that the examples may be practiced without these details. While a limited number of examples have been disclosed, those skilled in the art will appreciate numerous modifications and variations therefrom. It is intended that the appended claims cover such modifications and variations as fall within the scope of the examples. Throughout the present disclosure, the terms “a” and “an” are intended to denote at least one of a particular element. In addition, as used herein, the term “includes” means includes but not limited to, the term “including” means including but not limited to. The term “based on” means based at least in part on.

Some additive manufacturing systems use build materials to build three dimensional objects. Said additive manufacturing systems may comprise a build material processing unit therein or externally connected to supply build material to the three dimensional printer (e.g., 3D build chamber). The build material processing units may comprise at least one container comprising build material along with some mechanism to supply said build material to the additive manufacturing systems attached thereto.

Customers may acquire build materials in larger containers than the build material processing unit inner container. In some examples, build materials from said larger containers may be extracted to refill the build material processing unit inner container from said additive manufacturing system with build material. Some examples of the inner container of the build material processing units may range from smaller containers of about 30 liters to larger containers of about 300 liters. Another example of inner container may be an intermediate bulk container (IBC) of about 136 liters. Using relatively big build material containers (e.g., octabins of about 1500 liters) may allow the manufacturer to generate a greater plurality of three-dimensional (3D) objects using build material from the same batch. Therefore, using said containers may reduce the variability of the properties of the generated 3D objects built by using build materials from different batches of build material. Using said big build material containers may be commercially attractive due to a lower transportation cost of the build material stored therein.

One example of the present disclosure provides an apparatus to transfer additive manufacturing build material from a container. The apparatus comprises a holding structure and a conduit. The holding structure comprises a fixation element to physically attach the holding structure to one or multiple of sides of the container. The conduit may be couplable to a vacuum system through a vacuum open end to extract the build material. The holding structure receives and positions the conduit substantially vertically such that a build material extraction open end of the conduit is positioned towards the base of the container. The vacuum open end and the build material extraction open end are opposite open ends from the conduit.

Another example of the present disclosure provides a kit to transfer additive manufacturing build material from a container. The kit comprises a holding structure comprising a fixation element to physically attach the holding structure to one or multiple of sides of the container. The kit also comprises a conduit couplable to a vacuum system through a vacuum open end to extract build material, wherein the holding structure is to receive the conduit and position it substantially vertically such that a build material extraction open and of the conduit is positioned towards the base of the container, wherein the vacuum open end and the build material extraction open end are opposite open ends from the conduit.

In yet another example of the present disclosure, a method comprising a plurality of operations to be performed is disclosed. The method comprises physically attaching a fixation element from a holding structure to one or multiple sides of a container comprising additive manufacturing build material. The method also comprises installing a conduit to the holding structure so that the conduit is positioned substantially vertically such that a build material extraction open end of the conduit is positioned towards a base of the container. The method further comprises coupling the conduit to a vacuum system through a vacuum open end, wherein the vacuum open end and the build material extraction open end are opposite open ends. The method further comprises extracting build material from the container.

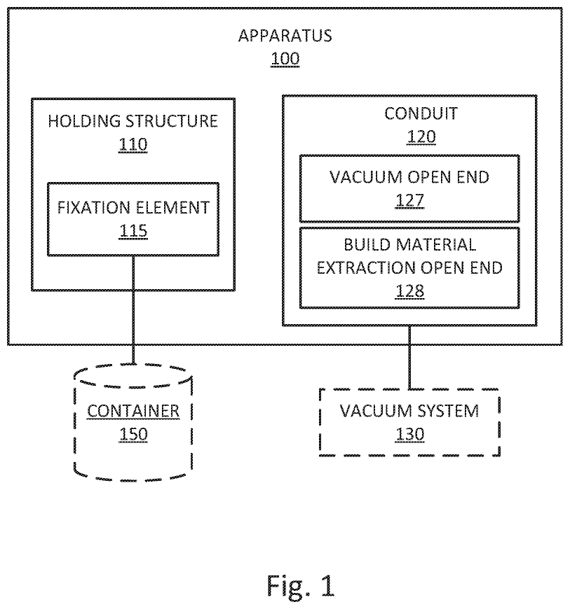

Referring now to the drawings, FIG. 1 is a block diagram illustrating an example of an apparatus 100 to extract build material. The apparatus 100 may be used to transfer additive manufacturing build material from a container 150. The container 150 may be any object that can be used to hold or transport build material. An example of a container 150 may be an octabin or similar bulk box. An octabin may be a light-weighted, and cost-effective packaging option used for transportation and storage of bulk cargo such as additive manufacturing build material. Octabins may be made from cardboard. In the example, the container 150 is not comprised in the apparatus 100. However, in other examples, the container 150 may be part of the apparatus 100. According to one example, a suitable build material may be PA12 build material commercially known as V1R10A “HP PA12” available from HP Inc. This is an example, and other build materials (e.g., other polymeric build material, metallic build material, ceramic build material) may be used without departing from the scope of the present disclosure.

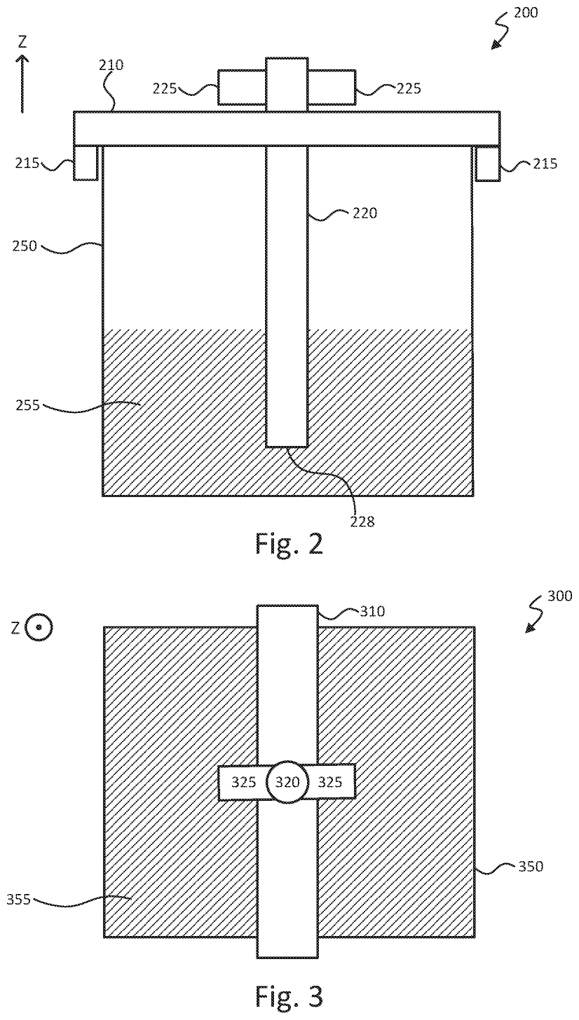

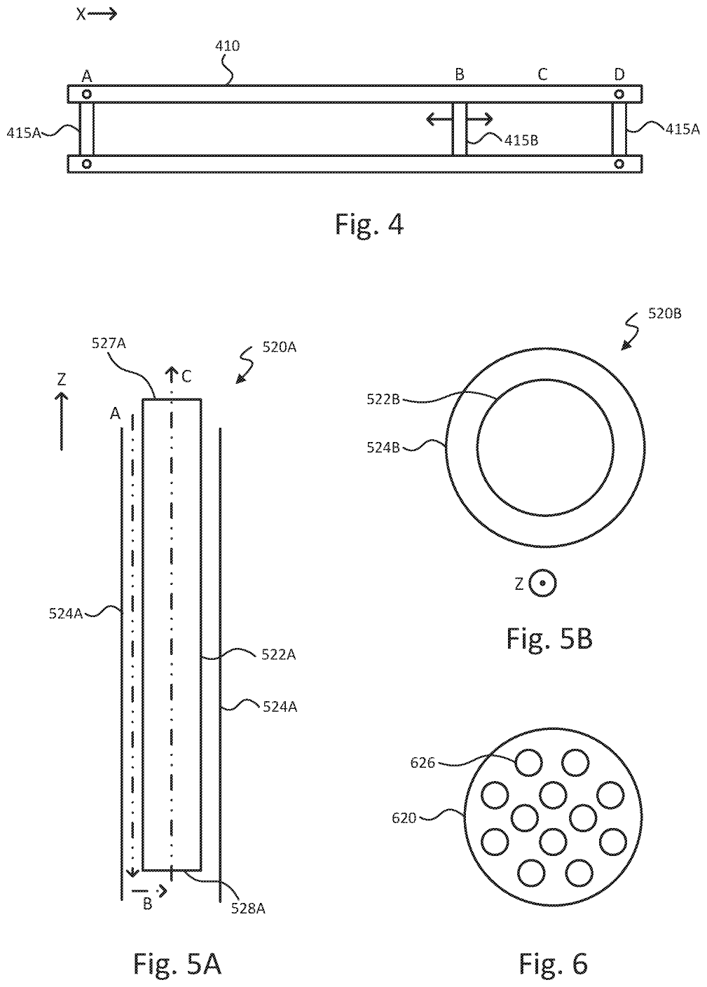

The apparatus 100 comprises a holding structure 110. The holding structure 110 comprises a fixation element 115 to physically attach the holding structure to one or multiple sides of a container 150 (e.g., the fixation element 115 may attach the holding structure to the walls of the container 150). In an example, the fixation element 115 may be a clamp, a brace, a band, a clasp, or any other mechanism used to strengthen or hold one or multiple sides of the container 150 together. An additional example of a holding structure 110 may be shown in FIG. 2 and/or in FIG. 4.

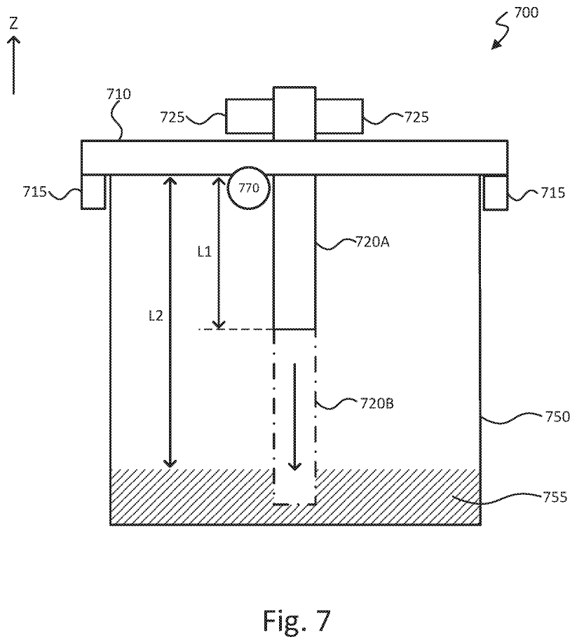

The apparatus 100 also comprises the conduit 120. In the present disclosure, a “conduit” should be understood as any channel for conveying a fluid (e.g., air) with or without build material. An example of a conduit is a tube that may have a circular section, or any other section. In an example, the conduit 120 may comprise a rigid or semi-rigid tube whose length is shorter than 50 centimeters (cm). In another example, the conduit 120 may comprise a rigid or semi-rigid tube whose length is shorter than 1 meter (m). In yet another example, the conduit 120 may comprise a rigid or semi-rigid tube whose length is shorter than 2 m. Additional examples may comprise a non-rigid tube. More examples of conduit are disclosed, for example, in FIG. 5A, FIG. 5B, and FIG. 7. The conduit 120 comprises two open ends: (i) a vacuum open end 127, and (ii) a build material extraction open end 128. The vacuum open end 127, and the build material extraction open end 128 may be opposite open ends from the conduit. The holding structure 110 is to receive the conduit 120 and position the conduit 120 substantially vertically such that the build material extraction open 128 end of the conduit 120 is positioned towards the base of the container 150. Additional examples of the conduit 120 are shown in FIG. 2, FIG. 5A, FIG. 6, and FIG. 7.

As used herein, terms “about” and/or “substantially” are used to provide flexibility to a numerical range endpoint by providing that a given value may be, for example, an additional 15% more or an additional 15% less than the endpoints of the range. The degree of flexibility of this term can be dictated by the particular variable and would be within the knowledge of those skilled in the art to determine based on experience and the associated description herein. In an example, when a conduit (e.g., conduit 120) is positioned substantially vertical, it may be understood that the length of the conduit 120 is positioned from −45° to 45° from the vertical axis defined by the normal vector from the base of the container 150.

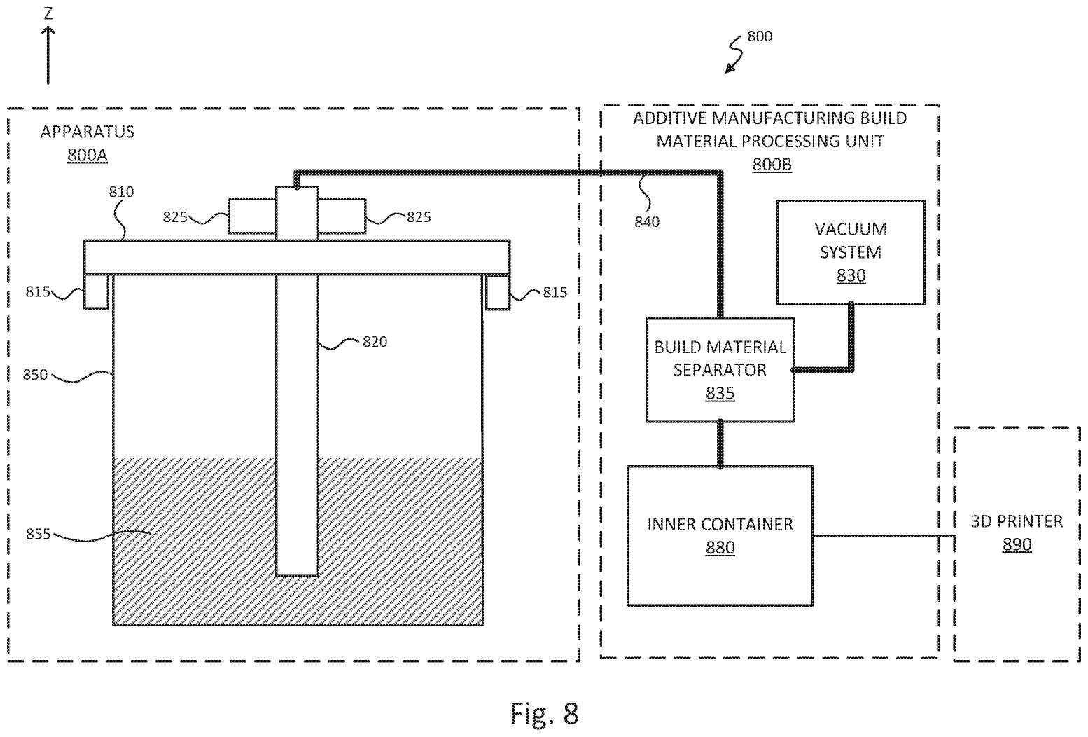

The build material extraction open end 128 from the conduit 120 may be submerged into the build material from the container 150 to be extracted. The build material (i) may be transferred from the build material extraction open end 128, (ii) may travel along the length of the conduit 120, and (iii) may be transferred to a receiving build material containing entity (e.g., the inner container 880 from the additive manufacturing build material processing unit 880B of FIG. 8) through the vacuum open end 127.

The conduit 120 is coupled to a vacuum system 130 through the vacuum open 127 end to extract build material from the container. In an example, the vacuum system 130 is not part of the apparatus 100. However, in other examples, the vacuum system 130 may be part of the apparatus 100. The vacuum system may be any device or mechanism to suck build material from the container 150. In additional examples, the vacuum system 130 may create a negative pressure which causes suction through the vacuum open end 127 from the conduit 120 to a receiving container. A fluid present in the build material extraction open end 128 (e.g., air) in conjunction with the vacuum system 130 may lead the build material from the container 150 to travel towards the receiving build material containing entity.

In an example, the conduit 120 and the holding structure 110 may be attached forming a single and inseparable element. The attachment may be made by welding the conduit 120 and the holding structure 110 together. This is an example, and many other attachment techniques may be used without departing from the scope of the present disclosure. In another example, the conduit 120 may be attached to the holding structure 110 in a releasable manner.

In an example, the apparatus 100 may be assembled or provided as a kit of parts. The apparatus 100 may be in a kit of parts when the holding structure 110 and the conduit 120 are dismounted separate elements, for example, when shipped, or when sold. The kit of parts elements may be assembled together to perform the functionality disclosed herein by the end user.

FIG. 2 is a schematic diagram illustrating an example of an apparatus 200 to extract build material 255. The build material 255 may be extracted from the container 250. The apparatus 200 comprises a holding structure 210, and a conduit 220. The holding structure 210, and the conduit 220, may be the same as or similar to the holding structure 110, and the conduit 120 of FIG. 1 respectively. The holding structure 210 comprises a fixation element 215 to physically attach the holding structure to one or multiple sides of the container 250. The fixation element 215 may be the same as or similar to the fixation element 115 from FIG. 1.

The apparatus 200 may also comprise a plurality of retaining elements 225 to hold the conduit 220 to the holding structure 210. In an example, the retaining elements 225 may position the conduit 220 within the holding structure 210 so that the conduit 220 build material extraction open end 128 is submerged in the build material 255 from the container 250. Some examples of holding structure 210 comprise a holding structure surface with a groove, spline and/or rabbet (see, e.g., holding structure 410 from FIG. 4) so that the conduit 220 may slide though said groove, spline and/or rabbet to be positioned in a build material extraction position, by sitting the retaining elements 225 on the holding structure surface. In the example, the retaining elements 210 may be elements attached to the conduit 220 that may work as stoppers, so that the retaining elements 210 sit on the holding structure 210 when the apparatus 200 is in use. In another example, the retaining elements 210 are elements attached to the conduit 220 that grip the conduit 220 to the holding structure 210 when the apparatus 200 is in use.

FIG. 3 is a schematic cross-section diagram illustrating another example of an apparatus 300 to extract build material. The build material 355 may be extracted from the container 350. Apparatus 300 comprises a holding structure 310, and a conduit 320. The holding structure 310, and the conduit 320, may be the same as or similar to the holding structure 110, and the conduit 120 of FIG. 1 respectively. The holding structure 310 comprises a fixation element 315 to physically attach the holding structure to one or multiple sides of the container 350. The fixation element 315 may be the same as or similar to the fixation element 115 from FIG. 1. The apparatus 300 may be a top view from the apparatus 200 from FIG. 2.

The apparatus 300 may also comprise a plurality of retaining elements 325 to hold the conduit 320 to the holding structure 310. In an example, the retaining elements 325 may position the conduit 320 within the holding structure 310 so that the conduit 320 build material extraction open end is submerged in the build material 355 from the container 350. Some examples of holding structure 310 comprise a holding structure surface with a groove, spline and/or rabbet so that the conduit 320 may slide though said groove, spline and/or rabbet to be positioned in a build material extraction position, by sitting the retaining elements 325 on the holding structure surface.

FIG. 4 is a schematic top view diagram illustrating an example of a holding structure 410. The holding structure 410 may be the same as or similar to the holding structure 110 from FIG. 1. The holding structure 410 may comprise two rails connected by rail connections 415A. The rail connections 415A may be fixed connections that may define the width of the holding structure 410 and the maximum length of the holding structure 410. In an example, the rail connections 415A comprises the fixations elements (e.g., fixation elements 115 from FIG. 1) to physically attach the holding structure 410 to one or multiple sides of a container (e.g., container 150 from FIG. 1). In another example, the fixation elements may be attached to the rails.

The holding structure 410 may also comprise an adjusting mechanism 415B to adjust the distance between the retaining elements to one or multiple sides of the container. The adjusting mechanism 415B may be adjusted by sliding said adjusting mechanism 415B through the length of the holding structure 410 (e.g., illustrated axis X), so that the holding mechanism 410 is adjustable to any size of container. This is an example, and many other implementations of the adjusting mechanism 415B adjustments may be used. The adjusting mechanism 415B comprises retaining elements.

In an additional example, the holding structure 410 may comprise a plurality of adjusting elements 415B. In an example, the distance between a first end of the holding structure 410 (point A) to a first adjusting element 415B position (point B) may be adjusted to be about 50 cm, therefore being suitable to containers whose walls are separated by about 50 cm. In another example, the distance between a first end of the holding structure 410 (point A) to a second adjusting element 415B position (point C) may be adjusted to be about 1 m, therefore being suitable to containers whose walls are separated by about 1 m. In yet another example the distance between a first end of the holding structure 410 (point A) to a second adjusting element 415B position (point D) may be adjusted to be about 2 m, therefore being suitable to containers whose walls are separated by about 2 m. In the illustrative example of FIG. 4, the adjusting mechanism 415B of the third example may be placed at the second end 415A. In a similar example, the adjusting mechanism 415B may be removable from the holding structure 410. A plurality of examples have been disclosed, however other examples can be derived therefrom without departing from the scope of the present disclosure, for example, by using a different adjusting mechanism 415B, and/or using different distances between the first end of the holding structure 410 and the adjusting mechanism 415B.

In an additional example, the holding structure 410 may comprise a cross-shaped structure, wherein (i) the center of the cross may be placed substantially in the center of the container and (ii) the edges of the cross may comprise fixation elements to physically attach the holding structure to one or multiple sides of the container. This example may further comprise a plurality of adjusting mechanisms 415B to adjust the distance between the retaining elements to one or multiple sides of said container. In an example, an adjusting element 415B may be placed in each edge of the cross-shaped holding structure 410. A conduit (e.g., conduit 120 from FIG. 1) may be placed within the cross-shaped holding structure 410 to extract build material from the container. Many other holding structure 410 shapes may be derived from this example without departing from the scope of the present disclosure.

FIG. 5A is a schematic diagram illustrating an example of a conduit 520A. The conduit 520A may be the same as or similar to the conduit 120 from FIG. 1. The conduit 520A comprises an outer tube 524A and an inner tube 522A. In an example, the outer tube 524A section and the inner tube 522A may be cylindrical tubes. In another example, the outer tube 524A and the inner tube 522A may have a section other than a circle (e.g., square, rectangle, ellipse, and the like). The outer tube 524A perimeter may be bigger than the inner tube 522A perimeter (see, e.g., outer tube 524B and inner tube 522B from FIG. 5B), therefore allowing a fluid (e.g., atmospheric air) to flow through the gap between the outer tube 524A and the inner tube 522A.

The conduit 520A may have two ends: (i) a vacuum open end 527A; and (ii) a build material extraction open end 528A. In the example, the vacuum open end 527A may be the open end illustrated in a higher position (axis Z). The gap between the outer tube 524A and the inner tube 522A provides an open end so that atmospheric air may flow therein. The vacuum open end 527A may be couplable to a vacuum system (e.g., vacuum system 130 from FIG. 1).

The build material extraction open end 528A is to be submerged in build material. When the conduit 520A is installed for build material extraction, an air flow (dotted line) may be defined. The atmospheric air may follow the air flow path: (i) the atmospheric air may be in suspension outside the conduit 520A (e.g., point A); (ii) the atmospheric air may flow through the gap between the outer tube 524A and the inner tube 522A until it meets the build material (e.g., from point A to point B); and (iii) the air may drag some build material particles and the mix of air and build material may flow through the inner volume from the inner tube 522A (e.g., point B to point C) towards the vacuum open end 528A.

In an example, the length of the outer tube 524A is substantially the same as the length of the inner tube 522A. In an additional example, the length of the outer tube 524A is shorter than the length of the inner tube 522A. In yet an additional example, the length of the outer tube 524A is longer than the length of the inner tube 522A.

FIG. 5B is a schematic diagram illustrating a cross-section example of a conduit 520B. The conduit 520B may be the same as or similar to the conduit 120 from FIG. 1. In an example, the conduit 520B may be a cross-section of the conduit 520A. The conduit 520B comprises an outer tube 524B and an inner tube 522B. The outer tube 524B and the inner tube 522B may be the same as or similar to the outer tube 524A and the inner tube 522A. In an example, the outer tube 524B section and the inner tube 522B may be cylindrical tubes (as illustrated). In another example, the outer tube 524B and the inner tube 522B may have a section other than a circle (e.g., square, rectangle, ellipse, and the like). The outer tube 524B perimeter may be bigger than the inner tube 522B perimeter, therefore allowing a fluid (e.g., atmospheric air) to flow through the gap between the outer tube 524B and the inner tube 522B.

FIG. 6 is a schematic diagram illustrating another cross-section example of a portion of the conduit 620. Conduit 620 may be the same as or similar to conduit 120 from FIG. 1. Conduit 620 may also be similar to the conduit 220 from FIG. 2, conduit 320 from FIG. 3, conduit 520A from FIG. 5A, and/or conduit 520B from FIG. B. In an example, the build material extraction open end may comprise a sieve 626 big enough to allow build material to flow therein but small enough to prevent other objects to flow therein. In another example, the vacuum open end (and/or the gap between an outer tube and an inner tube, see, e.g., FIGS. 5A and 5B) may comprise a sieve 626 big enough to allow build material to flow therein but small enough to prevent other objects to flow therein.

FIG. 7 is a schematic diagram illustrating another example of an apparatus 700 to extract build material. The apparatus 700 may be the same as or similar to apparatus 100 from FIG. 1 and/or the apparatus 200 from FIG. 2. Apparatus 700 may be to extract build materials 755 from the container 750. The apparatus 700 comprises a holding structure 710, and a conduit 720A. The holding structure 710, and the conduit 720A, may be the same as or similar to the holding structure 110, and the conduit 120 of FIG. 1 respectively. The holding structure 710 comprises a fixation element 715 to physically attach the holding structure 710 to one or multiple sides of the container 750. The fixation element 715 may be the same as or similar to the fixation element 115 from FIG. 1. The apparatus 700 may further comprise a plurality of retaining elements 725 to hold the conduit 720A to the holding structure 710. The plurality of retaining elements 725 may be the same as or similar to the plurality of retaining elements 225 from FIG. 2.

The conduit 720A may comprise a telescopic tube 720B to modify the length of the conduit. In an example, the conduit 720A spans a length (e.g., length L1) from the holding structure 710 and the build material level is at a distance (e.g., distance L2) from the holding structure 710, wherein L1 is shorter than L2. In said example, any portion of the conduit 720A is submerged into the build material 755 therefore, not enabling the build material 755 extraction from the container 750. The telescopic tube 720B may be engaged to increase the length of the conduit so that at least a portion of the conduit is submerged into the build material 755. The telescopic tube 720B may be engaged by a user or by electronic and/or mechanical means.

In an example, the telescopic tube 720B may be a tube connected to the conduit 720A by means of a screw mechanism so that a user or mechanic means can screw it to modify the length of the conduit 720A and telescopic tube 720B. In another example, the telescopic tube 720B may be a tube connected to the conduit by means of a motor control mechanism, so that the user may control said motor control mechanism to modify the length of the conduit 720A and the telescopic tube 720B. In another example, the telescopic tube 720B may be a tube connected to the conduit by means of a servomotor mechanism, so that the user may control said servomotor mechanism to modify the length of the conduit 720A and the telescopic tube 720B. In yet another example, the telescopic tube 720B may be a tube connected to the conduit 720A by means of a plurality of stoppers, wherein the user can modify the length of the conduit 720A and the telescopic tube 720B by changing the stopper position of the telescopic tube 720B with regards to the conduit 720A.

In an example, the system 700 may also comprise a build material level sensor 770 in connection with a controller (not shown). The telescopic tube 720B may also be in connection with the controller. The controller connection may be by means of a physical wire and/or wireless. The build material level sensor 770 may be installed, for example, in the holding structure 710. The build material level sensor 770 may be also installed in other parts of the apparatus 700, such as, the plurality of retaining elements 725, on the conduit 720A walls, etc. The build material level sensor 770 may measure the distance from the build material level sensor 770 (e.g., the holding structure 710) to the build material 755 level. The term “controller” as used herein may include a series of instructions encoded on a machine-readable storage medium and executable by a single processor or a plurality of processors. Additionally, or alternatively, a controller may include one or more hardware devices including electronic circuitry, for example a digital and/or analog application-specific integrated circuit (ASIC), for implementing the functionality described herein. The controller may instruct the build material level sensor 770 to measure the distance between the holding structure 710 and the build material 755 level (e.g., distance L2). The controller may instruct the telescopic tube 720B to adjust the length of the conduit 720A based on the build material level sensor 770 measurement, so that the build material extraction open end of the conduit is submerged into the build material 755. This is an example and many other similar examples may be derived therefrom without departing from the scope of the present disclosure.

FIG. 8 is a schematic diagram illustrating another example of an apparatus 800 to extract build material. Apparatus 800 comprises an apparatus 800A and an additive manufacturing system 800B.

The apparatus 800A may be the same as or similar to apparatus 100 from FIG. 1. The build materials 855 may be extracted from the container 850. The apparatus 800A comprises a holding structure 810, and a conduit 820. The holding structure 810, and the conduit 820, may be the same as or similar to the holding structure 110, and the conduit 120 of FIG. 1 respectively. The holding structure 810 comprises a fixation element 815 to physically attach the holding structure to one or multiple sides of the container 850. The fixation element 815 may be the same as or similar to the fixation element 115 from FIG. 1. Apparatus 800 may comprise a plurality of retaining elements 825 to hold the conduit 820 to the holding structure 810. The retaining elements 825 may be the same as or similar to the retaining elements 225 from FIG. 2.

The additive manufacturing build material processing unit 800B may comprise a 3D printer 890 in connection with an inner container 880. The inner container 880 may supply the 3D printer 890 with build material so that the 3D printer 890 may generate a 3D object. In an example, the inner container 880 may be part of the 3D printer 890. In another example, the inner container 880 may be a separate entity from the 3D printer 890. The additive manufacturing build material processing unit 800B may also comprise a vacuum system 830 and a build material separator 835. The vacuum system 830 may be the same as or similar to the vacuum system 130 from FIG. 1.

The vacuum open end of the conduit 820 and the inner container 880 may be connected through a hose 840. The hose 840 may also be coupled to the vacuum system 830. The vacuum system 830 may suck build material 855, so that the build material 855 flows through the conduit 820, and the hose 840, to be deposited into the inner container 880. The additive manufacturing build material processing unit 800B may further comprise a build material separator 835 connected into the hose 840. The build material separator 835 may split the fluid medium (e.g., air) from the build material 855, so that the build material 855 may be deposited to the inner container 880 free of fluid medium. The inner container 880 may supply the build material 855 to the 3D printer 890.

This is an example and many other similar apparatuses may be derived therefrom without departing from the scope of the present disclosure.

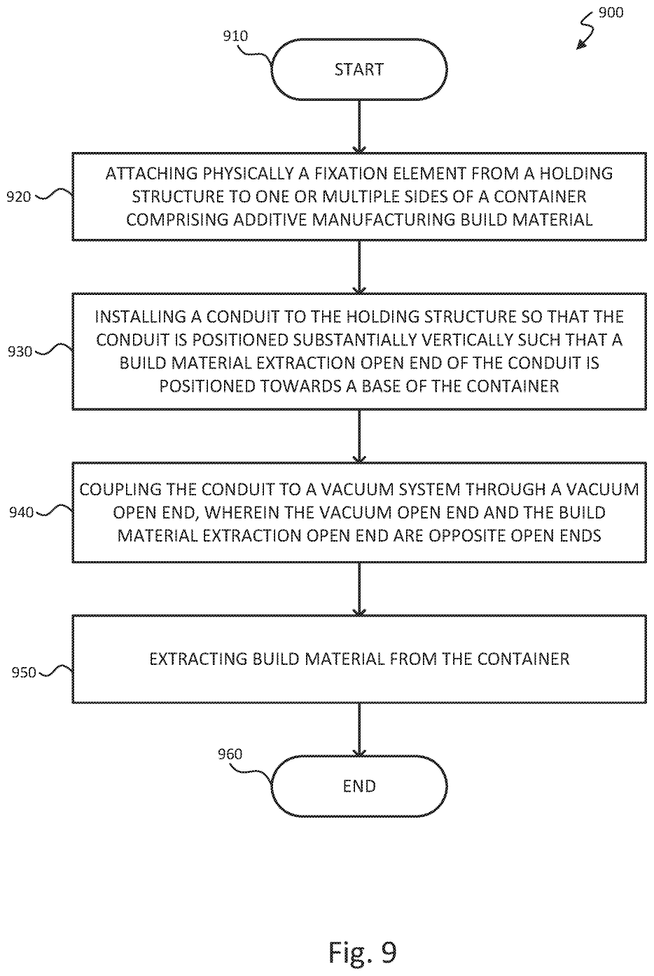

FIG. 9 is a flowchart of an example method 900 for extracting build materials. Method 900 may be described below as being executed or performed by an apparatus, such as apparatus 100 of FIG. 1. Various other suitable systems may be used as well, such as, for example apparatus 200 of FIG. 2, apparatus 300 of FIG. 3, apparatus 700 from FIG. 7, and apparatus 800 from FIG. 8. In some implementations of the present disclosure, method 800 may include more or less blocks than are shown in FIG. 8. In some implementations, one or more of the blocks of method 800 may, at certain times, be ongoing and/or may repeat.

Method 900 may start at block 910, and continue to block 920, where the user may physically attach a fixation element (e.g., fixation element 115 from FIG. 1) of a holding structure (e.g., holding structure 110 from FIG. 1) to one or multiple sides of a container (e.g., container 150 from FIG. 1) comprising additive manufacturing build material. At block 930, the user may install a conduit (e.g., conduit 120 from FIG. 1) to the holding structure so that the conduit is positioned substantially vertically such that a build material extraction open end (e.g., build material extraction open end 128 from FIG. 1) of the conduit is positioned towards a base of the container. At block 940, the user may couple the conduit to a vacuum system (e.g., vacuum system 130 from FIG. 1) through a vacuum open end (e.g., vacuum open end 127 from FIG. 1), wherein the vacuum open end and the build material extraction open end are opposite open ends. At block 950, the conduit extracts build material from the container. At block 960 the method may end.

The drawings in the examples of the present disclosure are some examples. Some examples, may include or may not include some units and functions of the procedure for implementing the present disclosure. The units may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

Example implementations can be realized according to the following clauses:

Clause 1: An apparatus to transfer additive manufacturing build material from a container comprising: (i) a holding structure comprising a fixation element to physically attach the holding structure to one or multiple sides of the container; and (ii) a conduit couplable to a vacuum system through a vacuum open end to extract the build material, wherein the holding structure receives and positions the conduit substantially vertically such that a build material extraction open end of the conduit is positioned towards a base of the container, wherein the vacuum open end and the build material extraction open end are opposite open ends from the conduit.

Clause 2: The apparatus of clause 1 comprising a plurality of retaining elements to hold the conduit to the holding structure.

Clause 3: The apparatus of any preceding clause, wherein the build material extraction open end of the conduit comprises a sieve.

Clause 4: The apparatus of any preceding clause wherein the conduit comprises a rigid or semi-rigid tube whose length is shorter than one of: (i) less than 50 centimeters (cm); (ii) less than 1 meter (m); or (iii) less than 2 m.

Clause 5: The apparatus of any preceding clause wherein the conduit comprises an outer tube and an inner tube, wherein the outer tube comprises an open end,
wherein the inner tube is couplable to the vacuum system and the build material from the container is to pass through the inner volume of the inner tube, and
wherein the outer tube open end is open to the atmosphere so that atmospheric air is to (i) flow through the volume defined between the inner tube and the outer tube towards the base of the container and, the atmospheric air is further to (ii) flow through the inner volume of the inner tube with the build material from the container towards the couple of the inner tube and the vacuum system.

Clause 6: The apparatus of any preceding clause, wherein the conduit tube comprises a telescopic tube to allow the length of the conduit to be modified.

Clause 7: The apparatus of any preceding clause comprising a build material level sensor, and a controller to: (i) instruct the build material level sensor to measure the distance between the holding structure and the build material level; and (ii) instruct the telescopic tube to adjust the length of the conduit based on the build material level sensor measurement, so that the build material extraction open end of said conduit is submerged into the build material.

Clause 8: The apparatus of any preceding clause wherein the holding structure comprises an adjusting mechanism to adjust the distance between the retaining elements to one or multiple sides of the container.

Clause 9: The apparatus of any preceding clause wherein the conduit and the holding structure are attached forming a single and inseparable element.

Clause 10: The apparatus of any preceding clause wherein the holding structure comprising a fixation element to attach to an octabin.

Clause 11: The apparatus of any preceding clause further comprising a hose to connect the vacuum open end of the conduit to an additive manufacturing build material processing unit.

Clause 12: A kit to transfer additive manufacturing build material from a container, the kit comprising: (i) a holding structure comprising a fixation element to physically attach the holding structure to one or multiple sides of the container; and (ii) a conduit couplable to a vacuum system through a vacuum open end to extract build material, wherein the holding structure is to receive the conduit and position it substantially vertically such that a build material extraction open end of the conduit is positioned towards the base of the container, wherein the vacuum open end and the build material extraction open end are opposite open ends from the conduit.

Clause 13: The kit of clause 12 comprising a plurality of retaining elements to hold the conduit to the holding structure.

Clause 14: The kit of any of clauses 12 to 13, wherein the build material extraction open end of the conduit comprises a sieve.

Clause 15: The kit of any of clauses 12 to 14 wherein the conduit comprises a rigid or semi-rigid tube whose length is shorter than one of: (i) less than 50 centimeters (cm); (ii) less than 1 meter (m); or (iii) less than 2 m.

Clause 16: The kit of any of clauses 12 to 15 wherein the conduit comprises an outer tube and an inner tube, wherein the outer tube comprises an open end,
wherein the inner tube is couplable to the vacuum system and the build material from the container is to pass through the inner volume of the inner tube, and
wherein the outer tube open end is open to the atmosphere so that an atmospheric air is to (i) flow through the volume defined between the inner tube and the outer tube towards the base of the container and, the atmospheric air is further to (ii) flow through the inner volume of the inner tube with the build material from the container towards the couple of the inner tube and the vacuum system.

Clause 17: The kit of any of clauses 12 to 16, wherein the conduit tube comprises a telescopic tube to allow the length of the conduit to be modified.

Clause 18: The kit of any of clauses 12 to 17 comprising a build material level sensor, and a controller to: (i) instruct the build material level sensor to measure the distance between the holding structure and the build material level; and (ii) instruct the telescopic tube to adjust the length of the conduit based on the build material level sensor measurement, so that the build material extraction open end of said conduit is submerged into the build material.

Clause 19: The kit of any of clauses 12 to 18 wherein the holding structure comprises an adjusting mechanism to adjust the distance between the retaining elements to one or multiple sides of the container.

Clause 20: The kit of any of clauses 12 to 19 wherein the conduit and the holding structure are attached forming a single and inseparable element.

Clause 21: The kit of any of clauses 12 to 20 wherein the holding structure comprising a fixation element to attach to an octabin.

Clause 22: The kit of any of clauses 12 to 21 further comprising a hose to connect the vacuum open end of the conduit to an additive manufacturing build material processing unit.

Clause 23: A method comprising:
attaching physically a fixation element from a holding structure to one or multiple sides of a container comprising additive manufacturing build material;
installing a conduit to the holding structure so that the conduit is positioned substantially vertically such that a build material extraction open end of the conduit is positioned towards a base of the container;
coupling the conduit to a vacuum system through a vacuum open end, wherein the vacuum open end and the build material extraction open end are opposite open ends; and
extracting build material from the container.

What it is claimed is:

1. An apparatus to transfer additive manufacturing build material from a container comprising:
a holding structure comprising a fixation element to physically attach the holding structure to one or multiple sides of the container; and
a conduit couplable to a vacuum system through a vacuum open end to extract build material, wherein the holding structure receives and positions the conduit substantially vertically such that a build material extraction open end of the conduit is positioned towards a base of the container, wherein the vacuum open end and the build material extraction open end are opposite open ends from the conduit.

2. The apparatus of claim 1 comprising a plurality of retaining elements to hold the conduit to the holding structure.

3. The apparatus of claim 1, wherein the build material extraction open end of the conduit comprises a sieve.

4. The apparatus of claim 1, wherein the conduit comprises a rigid or semi-rigid tube whose length is shorter than one of: (i) less than 50 centimeters (cm); (ii) less than 1 meter (m); or (iii) less than 2 m.

5. The apparatus of claim 1, wherein the conduit comprises an outer tube and an inner tube, wherein the outer tube comprises an open end,
wherein the inner tube is couplable to the vacuum system and the build material from the container is to pass through the inner volume of the inner tube, and
wherein the outer tube open end is open to the atmosphere so that atmospheric air is to (i) flow through the volume defined between the inner tube and the outer tube towards the base of the container and, the atmospheric air is further to (ii) flow through the inner volume of the inner tube with the build material from the container towards the couple of the inner tube and the vacuum system.

6. The apparatus of claim 1, wherein the conduit tube comprises a telescopic tube to allow the length of the conduit to be modified.

7. The apparatus of claim 6, comprising a build material level sensor, and a controller to:
instruct the build material level sensor to measure the distance between the holding structure and the build material level; and
instruct the telescopic tube to adjust the length of the conduit based on the build material level sensor measurement, so that the build material extraction open end of said conduit is submerged into the build material.

8. The apparatus of claim 1, wherein the holding structure comprises an adjusting mechanism to adjust the distance between the retaining elements to one or multiple sides of the container.

9. The apparatus of claim 1, wherein the conduit and the holding structure are attached forming a single and inseparable element.

10. The apparatus of claim 1, wherein the holding structure comprising a fixation element to attach to an octabin.

11. The apparatus of claim 1, further comprising a hose to connect the vacuum open end of the conduit to an additive manufacturing build material processing unit.

12. A kit to transfer additive manufacturing build material from a container, the kit comprising:
a holding structure comprising a fixation element to physically attach the holding structure to one or multiple sides of the container; and
a conduit couplable to a vacuum system through a vacuum open end to extract build material, wherein the holding structure is to receive the conduit and position it substantially vertically such that a build material extraction open end of the conduit is positioned towards the base of the container, wherein the vacuum open end and the build material extraction open end are opposite open ends from the conduit.

13. The kit of claim 12, wherein the build material extraction open end of the conduit comprises a sieve.

14. The kit of claim 12, wherein the conduit comprises a rigid or semi-rigid tube whose length is shorter than one of: (i) less than 50 centimeters (cm); (ii) less than 1 meter (m); or (iii) less than 2 m.

15. A method comprising:
attaching physically a fixation element from a holding structure to one or multiple sides of a container comprising additive manufacturing build material;
installing a conduit to the holding structure so that the conduit is positioned substantially vertically such that a build material extraction open end of the conduit is positioned towards a base of the container;
coupling the conduit to a vacuum system through a vacuum open end, wherein the vacuum open end and the build material extraction open end are opposite open ends; and
extracting build material from the container.
